(19) United States
(12) Patent Application Publication
(10) Pub. No.: US 2018/0267172 A1
(43) Pub. Date: Sep. 20, 2018

(54) SYSTEM AND METHOD FOR RECOGNIZING POSITION OF VEHICLE

(71) Applicants: HYUNDAI MOTOR COMPANY, Seoul (KR); KIA MOTORS CORPORATION, Seoul (KR)

(72) Inventors: Young Chul OH, Seongnam-si, Gyeonggi-do (KR); Ki Cheol SHIN, Seongnam-si, Gyeonggi-do (KR); Byung Yong YOU, Suwon-si, Gyeonggi-do (KR); Myung Seon HEO, Seoul (KR); Ha Yong WOO, Gwangmyeong-si (KR)

(73) Assignees: HYUNDAI MOTOR COMPANY, SEOUL (KR); KIA MOTORS CORPORATION, SEOUL (KR)

(21) Appl. No.: 15/717,064

(22) Filed: Sep. 27, 2017

(30) Foreign Application Priority Data
Mar. 20, 2017 (KR) 10-2017-0034705

(51) Int. Cl. G01S 19/45; G01C 21/36; G01S 17/02; G06K 9/00

(52) U.S. Cl. CPC G01S 19/45; G01C 21/3602; G05D 1/0278; G06K 9/00798; G01S 17/023

(57) ABSTRACT

The present disclosure provides a system for recognizing a position of a vehicle including: a lane-based position recognition device configured to extract correction information about a heading angle and a lateral position of the vehicle by comparing measured lane information with lane information on an accurate map; a LiDAR-based position recognition device that extracts correction information about a position of the vehicle by detecting an area in consideration of surrounding vehicles and obstacles measured through a LiDAR sensor; and a position assemble device configured to assemble a position based on the correction information about the heading angle and the lateral position of the vehicle, correction information about a heading angle, a longitudinal position and a lateral position of the vehicle from the LiDAR sensor, and correction information about a heading angle, a longitudinal position and a lateral position of the vehicle from GPS.

### CROSS-REFERENCE TO RELATED APPLICATION

The present application claims priority to and the benefit of Korean Patent Application No. 10-2017-0034705, filed on Mar. 20, 2017, which is incorporated herein by reference in its entirety.

### FIELD

The present disclosure relates to a system and a method for recognizing a position of a vehicle, and more particularly, to a technique for recognizing a position of a vehicle using a terrain, an object, or a landmark around the vehicle.

### BACKGROUND

The statements in this section merely provide background information related to the present disclosure and may not constitute prior art.

In general, an autonomous vehicle refers to a vehicle that recognizes a driving environment by itself and travels to a destination without an assistance of a driver. In order to utilize such an autonomous vehicle in the central area of a city, it is important to accurately recognize the driving environment. To this end, research has conducted on driving environment recognition technology that combines a global positioning system (GPS), map information, and various sensors.

In recent years, a driving environment recognition technology using a radar, a light detection and ranging (LiDAR) sensor and an image sensor has been introduced. Such conventional driving environment recognition technology merely combines an image sensor and a distance sensor without considering the accuracy of GPS information and map information. Therefore, it may be difficult to apply the conventional driving environment recognition technology in a complicated urban area.

In the related art, when a general map is used without an accurate map, although it is possible to perform a relatively accurate position match in a longitudinal direction, it may be difficult to perform a precise position match in a lateral direction.

In addition, the driving environment recognition technology using a radar, a LiDAR sensor and an image sensor may not accurately measure a position due to surrounding vehicles or obstacles.

### SUMMARY

The present disclosure provides a system and a method for recognizing a position of a vehicle, where heading angle and lateral position information of the vehicle is extracted by comparing lane information detected by a vehicle sensor with lane information on an accurate map, heading angle, longitudinal and lateral position information of the vehicle are extracted through a LiDAR sensor, position information, which is corrected at a position measured by using position information extracted from each sensor by extracting heading angle and longitudinal position information of the vehicle based on a GPS, is generated, and a position error prediction (boundary) value of the vehicle is extracted from the corrected position information.

In some forms of the present disclosure, a system for recognizing a position of a vehicle includes a lane-based position recognition device configured to extract correction information about a heading angle and a lateral position of the vehicle by comparing measured lane information with lane information on an accurate map, a LiDAR-based position recognition device that extracts correction information about a position of the vehicle by detecting an area in consideration of surrounding vehicles and obstacles measured through a LiDAR sensor, and a position assembly device configured to assemble a position using the correction information about the heading angle and the lateral position of the vehicle, correction information about a heading angle, a longitudinal position and a lateral position of the vehicle from the LiDAR sensor, and correction information about a heading angle, a longitudinal position and a lateral position of the vehicle using GPS.

In other forms of the present disclosure, a method of recognizing a position of a vehicle includes: extracting correction information about a heading angle and a lateral position of the vehicle by comparing measured lane information with lane information on an accurate map, extracting correction information about a position of the vehicle by detecting an area in consideration of surrounding vehicles and obstacles measured through a LiDAR sensor, and assembling a position fusion using the correction information about the heading angle and the lateral position of the vehicle, correction information about a heading angle, a longitudinal position and a lateral position of the vehicle from the LiDAR sensor, and correction information about a heading angle, a longitudinal position and a lateral position of the vehicle using GPS.

The method may further include predicting a moving route of the vehicle from a previous position to a current position before extracting the correction information about the heading angle and the lateral position of the vehicle.

The extracting of the correction information about the heading angle and the lateral position of the vehicle may include dividing a measured lane and a lane on the accurate map into a plurality of matching sections based on a longitudinal direction of the vehicle, and matching the measured lane with the lane on the accurate map.

The assembling the position may include: converting a final position for each sensor into a coordinate system based on the position of the vehicle, extracting heading angle correction information of the vehicle, extracting lateral position information of the vehicle, extracting longitudinal positional information of the vehicle, and converting the extracted information into global coordinates.

The extracting the correction information regarding the position of the vehicle may include: extracting an outline using a LiDAR signal, calculating a region of interest (ROI) of a matchable area from the outline, classifying feature lines in longitudinal, lateral, and diagonal directions, setting a matchable area based on the feature lines, extracting heading angle, longitudinal position, and a lateral position correction information of the vehicle for each outline, and calculating a weight for each outline.

The classifying the feature line in the longitudinal direction may include matching the feature line with the outline by using a lateral position error prediction value (E_LAT).

The classifying the feature line in the lateral direction may include matching the feature line with the outline by using a longitudinal position error prediction value (E_LONG).

The classifying the feature line in the diagonal direction may include: matching the feature line with the outline by using a longitudinal position error prediction value when lateral correction information exists, and matching the feature line with the outline by using the lateral and longitudinal position error prediction values when the lateral correction information does not exist.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given byway of example, reference being made to the accompanying drawings, in which:

FIG. 1 is a block diagram illustrating a system for recognizing a position of a vehicle;

FIG. 2 is a flowchart illustrating a method of recognizing a position of a vehicle;

FIGS. 3 and 4 are views illustrating a method of predicting an error of a vehicle position in a lateral direction based on a lane;

FIG. 5 is a flowchart illustrating a method of extracting position information through a LiDAR sensor;

FIGS. 6 and 7 are views illustrating a method of extracting position information through a LiDAR sensor and generating a matchable area based on the extracted position information;

FIG. 8 is a view illustrating a method of using a feature line generated in a longitudinal, lateral or diagonal direction through a LiDAR sensor;

FIG. 9 is a flowchart illustrating a method of fusing information extracted through a sensor to extract a vehicle position;

FIG. 10 is a view illustrating a method of fusing information extracted through a sensor to extract a vehicle position;

FIG. 11 is a flowchart illustrating a method of using error prediction values for a heading angle, a longitudinal position and a lateral portion of a vehicle; and

FIG. 12 is a block diagram illustrating a computer system executing a method of recognizing a position of a vehicle.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereinafter, forms of the present disclosure will be described in detail with reference to accompanying drawings.

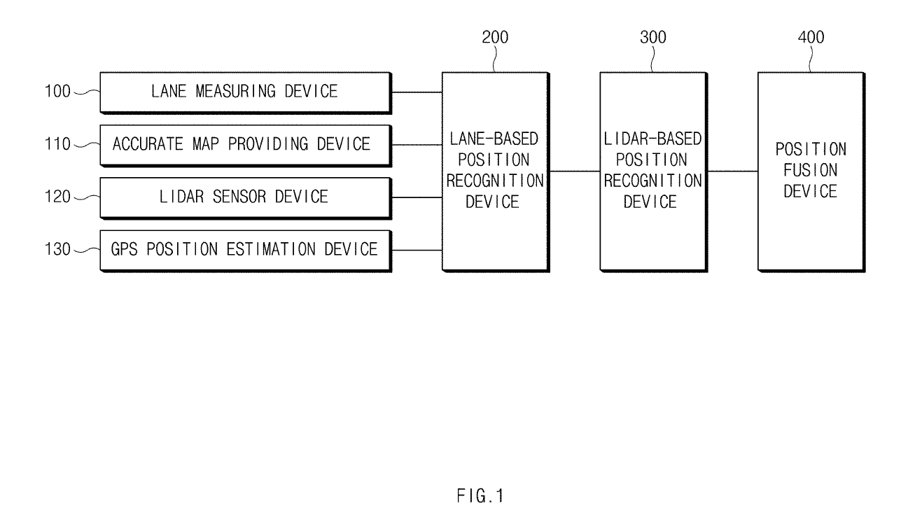

FIG. 1 is a block diagram illustrating a system for recognizing a position of a vehicle in some forms of the present disclosure.

Referring to FIG. 1, a system for recognizing a position of a vehicle includes a lane measuring device 100, an accurate map providing device 110, a LiDAR sensor device 120, a GPS position estimation device 130, a lane-based position recognition device 200, a LiDAR-based position recognition device 300, and a position fusion device 400.

The lane measuring device 100 measures a lane by recognizing a lane through a sensor or a camera provided in the vehicle. The sensor or the camera provided in the vehicle is installed to the vehicle to acquire surrounding images (such as a forward image, a rear image, a side image, etc.) of the vehicle. Such a camera may include a single camera, a stereoscopic camera, a panoramic camera, a monocular camera, etc.

The accurate map providing device 110 provides an accurate map stored in the vehicle, and the accurate map has lane information, position information obtained by measuring surrounding buildings, landmarks, and the like.

In detail, the accurate map providing device 110 provides map data including terrain feature information such as a point of interest (POI) or a region of interest (ROI) information, landmark information, and the like. In this case, the map data are data of an accurate map (1:25,000 or more scale) and/or a general map (1:25,000 or less scale). The accurate map has more terrain feature information, such as POI information, ROI information, landmark information, and the like, than the general map.

The LiDAR sensor device 120 measures surrounding vehicles and obstacles using a LiDAR sensor provided in the vehicle.

In detail, the LiDAR sensor device 120 detects an object existing around the vehicle and measures the distance between the vehicle and the object (a target to be measured, an object, an obstacle, a vehicle, etc.). That is, the LiDAR sensor device 120 may detect information about an object located around the vehicle, and may be implemented with a radio detection and ranging (radar), a light detection and ranging (LiDAR), an ultrasonic sensor, an infrared sensor, etc.

The GPS position estimation device 130 estimates a current position of the vehicle using GPS.

In detail, the GPS position estimation device 130 may include a GPS receiver that receives a navigation message broadcasted through a satellite and may confirm a current vehicle position, the total number of satellites capable of receiving satellite signals, the number of satellites capable of receiving a signal through a line of sight (LOS), and the current vehicle speed by using the navigation message (GPS information, GPS signals, satellite signals, etc.).

The lane-based position recognition device 200 compares the lane information measured by the lane measurement device 100 with the lane information on the accurate map provided by the accurate map providing device 110 to extract the current heading angle (heading direction) and the lateral position of the vehicle.

That is, the lane-based position recognition device 200 may extract the correction information about the heading angle and the lateral position based on the lane by mapping the measured lane information and the lane information on the accurate map.

The LiDAR-based position recognition device 300 extracts a heading angle, a longitudinal position and a lateral position based on the LiDAR sensor.

That is, the LiDAR-based position recognition device 300 detects an area capable of matching with the accurate map in consideration of the surrounding vehicles and obstacles measured by the LiDAR sensor of the LiDAR sensor device 120.

The position fusion device 400 performs a position fusion by using the correction information about the heading angle and the lateral position based on the extracted lane, the correction information about the heading angle, the longitudinal position and the lateral position based on the LiDAR sensor, and the correction information about the heading angle, the longitudinal position and the lateral position based on GPS.

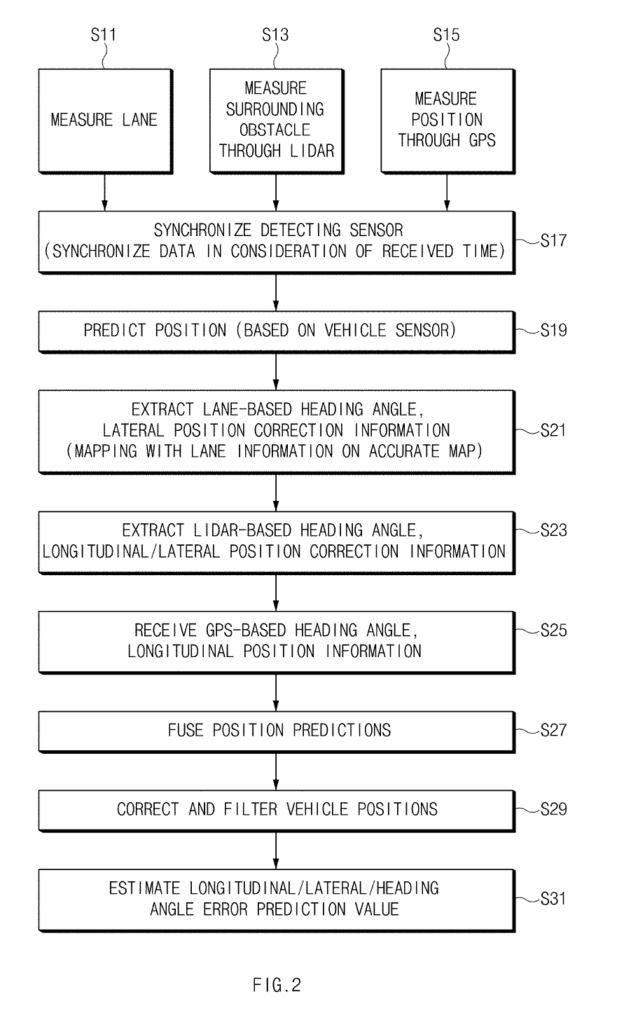

FIG. 2 is a flowchart illustrating a method of recognizing a position of a vehicle in some forms of the present disclosure.

Referring to FIG. 2, in operations S11 through S15, the system for recognizing a position of a vehicle measures a lane by recognizing the lane through the sensor or the camera provided in the vehicle, measures surrounding vehicles and obstacles through the LiDAR sensor provided in the vehicle, and receives a current vehicle position through the GPS.

Then, in operation S17, the system for recognizing a position of a vehicle corrects the received signals (data) by synchronizing the signals received from the sensors to correspond to signal periods or timings because the signal periods or timings of the sensors provided in the vehicle are different from each other.

In operation S19, the system for recognizing a position of a vehicle predicts from the previous position of the vehicle to the current position by using the sensors provided in the vehicle.

In this case, according to the method of predicting from the previous position to the current position, the moving range of the vehicle may be predicted by using a yaw rate or speed of the vehicle from a sensor provided in the vehicle.

In operation S21, the system for recognizing a position of a vehicle compares the measured lane information with the lane information on the accurate map to extract the current heading angle and lateral position of the vehicle.

That is, the system for recognizing a position of a vehicle may extract the correction information about the heading angle and the lateral position based on the lane by mapping the measured lane information and the lane information on the accurate map.

In operation S23, the system for recognizing a position of a vehicle extracts the heading angle, the longitudinal position and the lateral position of the vehicle based on the LiDAR sensor.

That is, the system for recognizing a position of a vehicle may detect the area matchable with the accurate map in consideration of the surrounding vehicles and obstacles measured through the LiDAR sensor.

In this case, the matchable area may be an ROI.

Here, the system for recognizing a position of a vehicle may extract the correction information about the longitudinal position, the lateral position, and the heading angle by using the information about the lane-based lateral position.

In operation S25, the system for recognizing a position of a vehicle extracts the correction information about the heading angle and the longitudinal position of the vehicle by using the GPS.

In operations S27 to S29, the fused vehicle position is extracted by applying a high weight to a small difference between the predicted vehicle position extracted by each sensor and the (current) predicted vehicle position by fusing all information about the extracted lane-based heading angle and lateral position, information about the heading angle, longitudinal position and lateral position of the vehicle based on the LiDAR sensor, and information about the heading angle and longitudinal position of the vehicle by using the GPS.

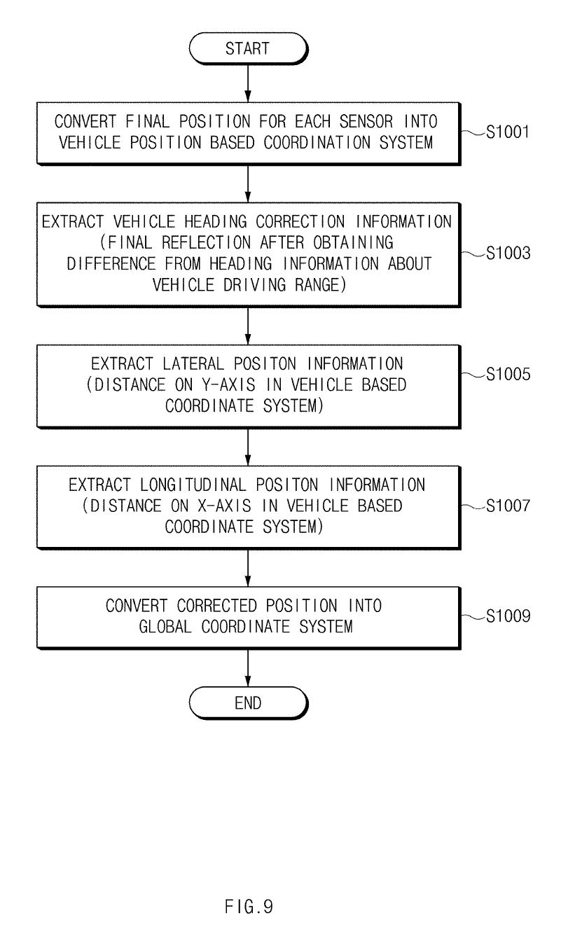

The details about the method of fusing the information extracted from the sensors to extract the position of the vehicle will be described with reference to FIG. 9.

Next, in operation S31, the heading angle error prediction value, the longitudinal position error prediction value and the lateral position error prediction value of the vehicle are extracted using the predicted current vehicle position and the corrected position.

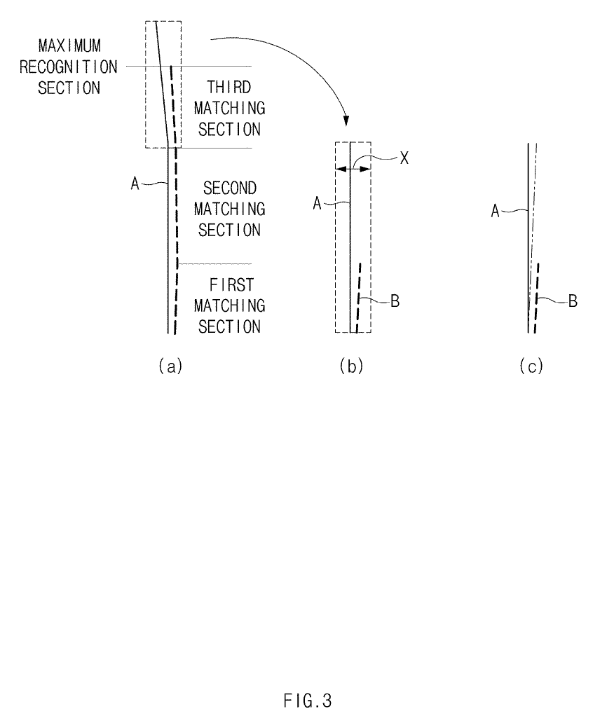

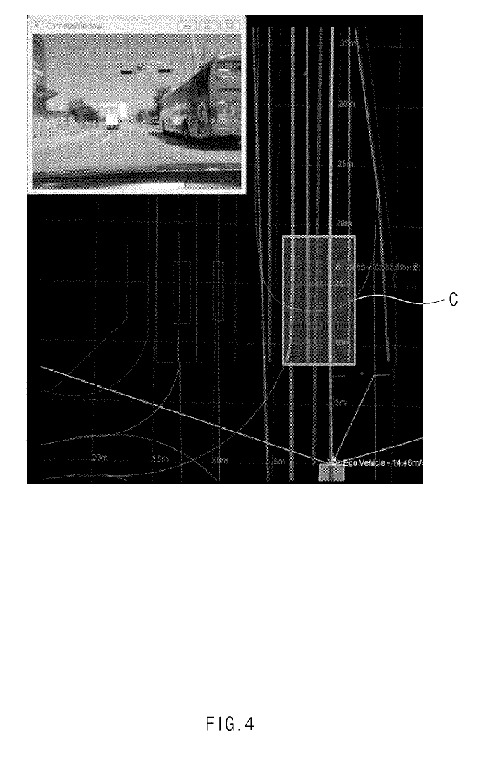

FIGS. 3 and 4 are views illustrating a method of predicting an error of a vehicle position in a lateral direction based on a lane in some forms of the present disclosure.

Referring to FIGS. 3A to 3C, when the system for recognizing a position of a vehicle matches lane ‘A’ on the accurate map with measured lane ‘B’, the lane ‘A’ may be divided into first to third matching sections.

That is, the system for recognizing a position of a vehicle may divide the matching section into three sections based on the longitudinal direction of the vehicle corresponding to the maximum recognition section (MAX View Range).

If the lane on the accurate map is matched with the measured lane in the first matching section (low stage matching section) among the divided matching sections, the system for recognizing a position of a vehicle does not perform matching in the second or third matching section.

In addition, when the lane ‘A’ on the accurate map and the measured lane ‘B’ are detected within the range of the lateral position error prediction (boundary) value E_LAT and the difference in slope between the lane ‘A’ on the accurate map and the measured lane ‘B’ is within the heading angle error prediction value E_ANGLE, the system for recognizing a position of a vehicle matches the lane ‘A’ on the accurate map with the measured lane ‘B’ (See ‘X’).

Since the slope of the lane ‘A’ on the accurate map and the slope of the measured lane ‘B’, which are matched each other, are different from each other, the system for recognizing a position of a vehicle extracts and corrects the heading angle of the vehicle such that the slopes become equal to each other, so that the slopes of the two lanes become parallel to each other.

In addition, the system for recognizing a position of a vehicle may extract the current vehicle position by extracting vector information from the lane ‘A’ on the accurate map and the measured lane ‘B’.

Referring to FIG. 4, the system for recognizing a position of a vehicle may recognize the position of the vehicle even when the vehicle passes through an intersection ‘C’ where the lane on the accurate map and the measured lane are both disconnected.

That is, in the case where the lane is temporarily disconnected when the vehicle passes through the intersection ‘C’ or there is no lane, since the system for recognizing a position of a vehicle is capable of detecting a near lane and a far lane, the system for recognizing a position of a vehicle may extract the lateral position of the vehicle by using the matching information in each matching section.

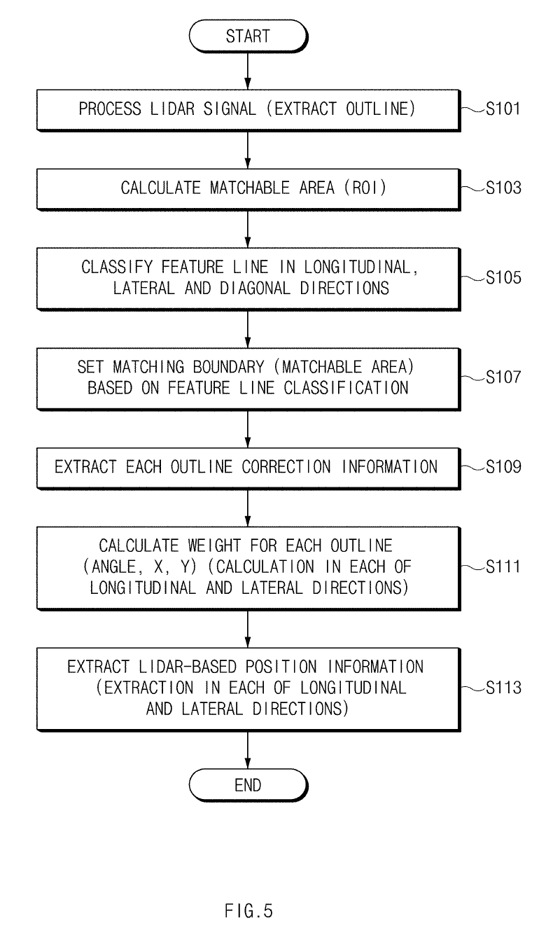

FIG. 5 is a flowchart illustrating a method of extracting position information through a LiDAR sensor in some forms of the present disclosure.

In operation S101, the LiDAR sensor of the system for recognizing a position of a vehicle processes a LiDAR signal to extract an outline (contour) representing the behavior of a surrounding vehicle.

That is, the system for recognizing a position of a vehicle may change point cloud data extracted from the LiDAR sensor to an outline to calculate an ROI that is matched with the point cloud data.

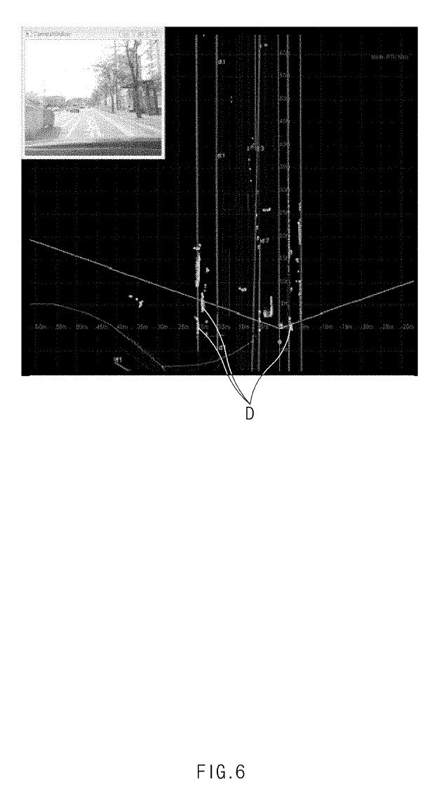

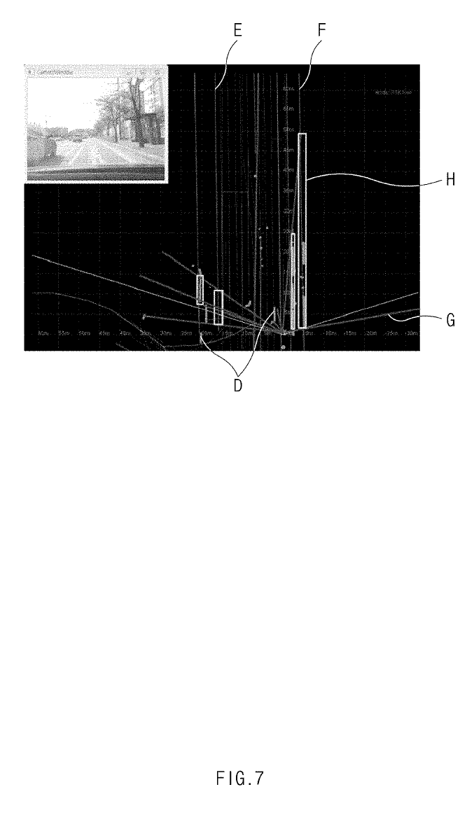

In operation S103, the system for recognizing a position of a vehicle calculates the matchable area, that is, the ROI. The details about the method of generating the matchable area will described with reference to FIGS. 6 and 7.

Here, the system for recognizing a position of a vehicle calculates the ROI on the accurate map in consideration of the surrounding vehicle or the obstacle.

Then, in operation S105, the system for recognizing a position of a vehicle classifies the feature lines generated in the longitudinal direction, the lateral direction, and the diagonal direction of the vehicle.

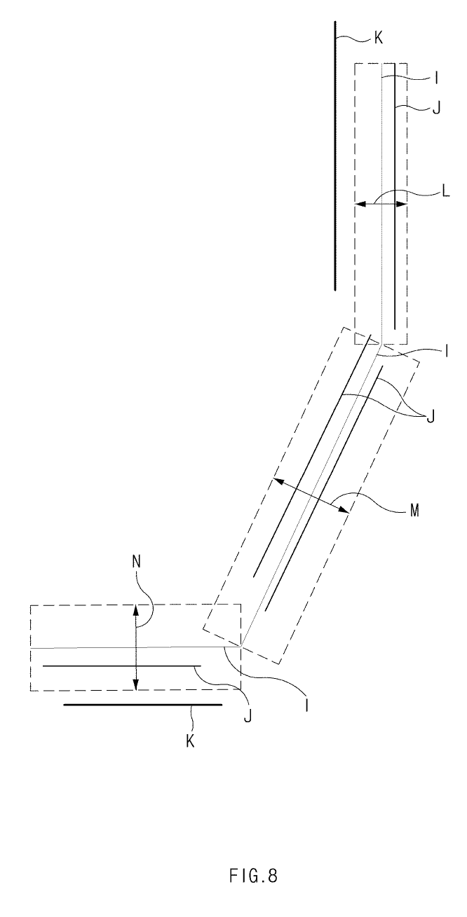

In this case, the feature line, which is a line segment detected on the accurate map, may be corrected by matching with the outline detected from the LiDAR sensor. The details about the method of matching a feature line with an outline will be described with reference to FIG. 8.

In operation S107, the system for recognizing a position of a vehicle sets a matching boundary (or, a matchable area or a matching area) corresponding to the feature line.

In operation S109, the system for recognizing a position of a vehicle extracts the correction information about the heading angle, the longitudinal position and the lateral position of the vehicle for each outline.

In operation S111, the system for recognizing a position of a vehicle calculates corresponding weights for each outline concerning the heading angle, and the longitudinal and lateral directions of the vehicle.

In operation S113, the system for recognizing a position of a vehicle extracts the LiDAR-based fused position information.

In detail, the system for recognizing a position of a vehicle classifies the outlines based on the feature lines classified in the longitudinal, lateral and diagonal directions of the vehicle, and extracts the heading angle correction information and the longitudinal and lateral position correction information of the vehicle for each of the classified outlines.

Next, after extracting the heading angle correction information and the longitudinal and lateral position correction information of the vehicle for each outline, the system for recognizing a position of a vehicle applies a high weight to the result of a small difference in the position information predicted for each correction information such that fused correction information is finally extracted.

FIGS. 6 and 7 are views illustrating a method of extracting position information through a LiDAR sensor and generating a matchable area based on the extracted position information, where an obstacle or a landmark including a curb ‘E’, a wall ‘F’, and the like exists around a road on which the vehicle travels.

Referring to FIG. 6, the system for recognizing a position of a vehicle processes the LiDAR signal received from the LiDAR sensor to calculate a matchable ROI, thereby extracting the outline ‘D’.

In detail, after grouping the point cloud data collected from the LiDAR sensor through a grouping algorithm, the system for recognizing a position of a vehicle may track each object by 1:1 matching with each object, and may extract the outline ‘D’ corresponding to the object. The outline ‘D’ may include a plurality of straight lines.

Referring to FIG. 7, the system for recognizing a position of a vehicle extracts a straight line (G, radiation) in consideration of a radiation angle and a resolution of the LiDAR signal provided from the LiDAR sensor in the accurate map.

The system for recognizing a position of a vehicle stops expanding the radiation ‘G’ when the radiation ‘G’ meets the outline ‘D’.

In this case, when the radiation ‘G’ and the outline ‘D’ are matched to each other, the system for recognizing a position of a vehicle determines the outer line ‘D’ as the matchable area (matching area) ‘H’ and determines the matching area for the curb ‘E’ and the wall ‘F’ around the road on which the vehicle travels, where the outline ‘D’ by the curb ‘E’ is excluded, and the wall F having a high height may be matched.

FIG. 8 is a view illustrating a method of using a feature line generated in a longitudinal, lateral or diagonal direction through a LiDAR sensor in some forms of the present disclosure.

Referring to FIG. 8, the feature line (feature line ‘I’ on the accurate map) in which a difference exists in the heading angle (direction) of the vehicle is used for the lateral position correction, and the lateral position correction uses the lateral position error prediction value E_LAT. In this case, ‘L’ is a matching area on which a lateral position error prediction value is reflected, ‘N’ is a matching area on which a longitudinal position error prediction value is reflected, and ‘M’ is a matching area on which a large value among the longitudinal position and lateral position error prediction values is reflected.

That is, the system for recognizing a position of a vehicle may match the feature line ‘I’ corrected by using the lateral position error prediction value E_LAT with the outline (the contour line within the matching outline or the matching area) ‘J’. However, the system for recognizing a position of a vehicle does not perform matching between the feature line ‘I’ and the outline line ‘K’ excluded from matching. The outline ‘K’ that is excluded from matching may be a contour line extracted through the LiDAR sensor.

However, the feature line (feature line in the accurate map) ‘I’ having a difference of about 90 degrees (for example, 85 degrees to 95 degrees) from the heading angle (direction) of the vehicle is used for the longitudinal position correction. The longitudinal position error prediction value E_LONG is used for the longitudinal position correction.

The system for recognizing a position of a vehicle may match the corrected feature line ‘I’ with the outline ‘J’ using the longitudinal position error prediction value E_LONG.

The remaining lines (feature lines having a diagonal line shape on the accurate map) ‘I’ are used only for extracting the longitudinal position error prediction value E_LONG when there exists lateral position correction information, and are used for all the longitudinal position and lateral position corrections (a large value of E_LONG and E_LAT is applied) when there is no lateral position correction information.

FIG. 9 is a flowchart illustrating a method of fusing information extracted through a sensor to extract a vehicle position in some forms of the present disclosure.

Referring to FIG. 9, in operation S1001, the system for recognizing a position of a vehicle converts the final position of each sensor into a coordinate of the position of the vehicle.

The system for recognizing a position of a vehicle may convert positions of the vehicle and the surrounding vehicles into coordinates of an X-Y coordinate system.

Then, in operation S1003, the system for recognizing a position of a vehicle extracts the heading angle correction information of the vehicle.

After calculating the difference between the predicted heading angle information and the heading angle information received from the heading sensor provided in the vehicle, the system for recognizing a position of a vehicle determines the weight.

Then, in operation S1005, the system for recognizing a position of a vehicle extracts the lateral position information.

The system for recognizing a position of a vehicle measures a Y-axis distance in the coordinate system based on the position of the vehicle.

Then, in operation S1007, the system for recognizing a position of a vehicle extracts the longitudinal position information. That is, the system for recognizing a position of a vehicle measures an X-axis distance in the position-based coordinate system.

Then, in operation S1009, the system for recognizing a position of a vehicle converts the extracted (corrected) position into coordinates of a global coordinate system.

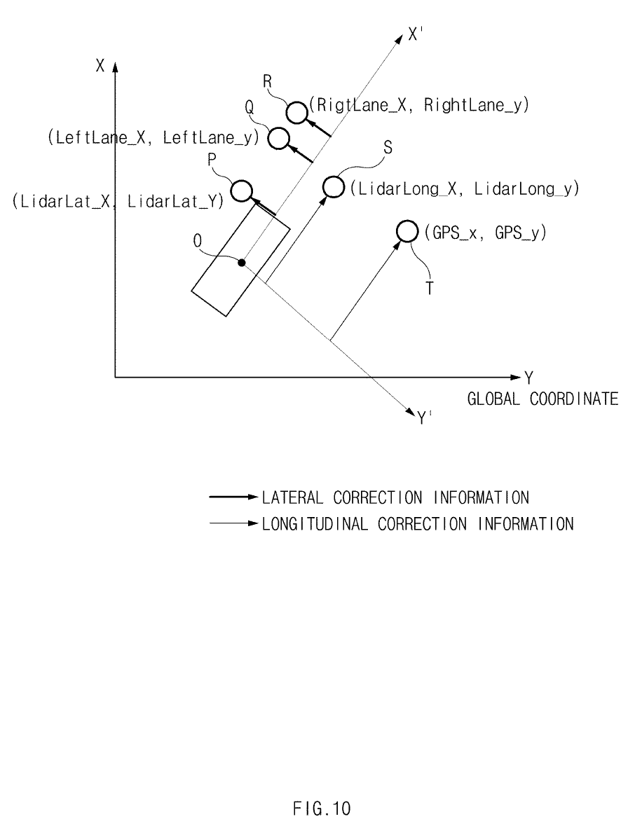

FIG. 10 is a view illustrating a method of fusing information extracted through a sensor to extract a vehicle position in some forms of the present disclosure.

Referring to FIG. 10, the system for recognizing a position of a vehicle may correct the heading angle (direction) and the lateral position of the vehicle by using the lane to represent the heading angle and the lateral position in the global coordinate system.

In addition, the system for recognizing a position of a vehicle may correct the heading angle, the longitudinal position, and the lateral position of the vehicle by using the LiDAR sensor and GPS to represent the heading angle, the longitudinal position, and the lateral position of the vehicle in the global coordinate system.

In this case, FIG. 10 illustrates global coordinates representing the lateral correction information and the longitudinal correction information including the driving range (DR_x, DR_y) ‘O’ of the vehicle, the LiDAR lateral direction (LidarLat_X, LidarLat_Y) ‘P’, the LiDAR longitudinal direction (LidarLong_X, LidarLong_Y) ‘Q’, the left lane direction (LeftLane_X, LeftLane_Y) ‘R’, the right lane direction (RightLane_X, RightLane_Y) ‘S’, and the GPS direction (GPS_X, GPS_Y) ‘T’.

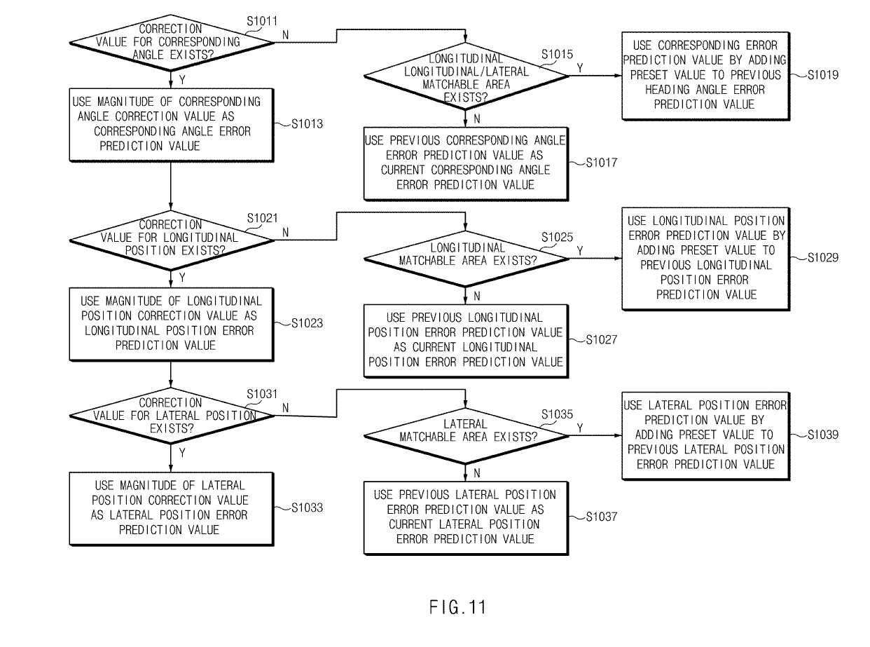

FIG. 11 is a flowchart illustrating a method of using error prediction values for a heading angle, a longitudinal position and a lateral portion of a vehicle in some forms of the present disclosure.

Referring to FIG. 11, in operations S1011 to S1013, if there is a correction value for the heading angle, the system for recognizing a position of a vehicle uses the magnitude of the heading angle correction value as the heading angle error prediction value.

Then, in operation S1015, if there is no correction value for the heading angle, the system for recognizing a position of a vehicle determines whether an area from which the heading angle can be extracted exists in the accurate map (whether the longitudinal and lateral matchable area exists).

In operation S1017, if the area from which the heading angle can be extracted does not exist in the accurate map, the system for recognizing a position of a vehicle uses the previous heading angle error prediction value as it is.

However, in operation S1019, if the area from which the heading angle can be extracted does not exist in the accurate map, the system for recognizing a position of a vehicle uses the heading angle error prediction value by adding a predetermined value (a preset value) to the previous heading angle error prediction value.

Then, in operation S1021 to S1023, if there is a correction value for the longitudinal position, the system for recognizing a position of a vehicle uses the magnitude of the longitudinal position correction value as the longitudinal position error prediction value.

Then, in operation S1025, if the longitudinal position correction value does not exist, the system for recognizing a position of a vehicle determines whether an area from which the longitudinal position can be extracted exists in the accurate map (whether the longitudinal matchable area exists).

In operation S1027, if the area from which the longitudinal position can be extracted does not exist in the accurate map, the system for recognizing a position of a vehicle uses the previous longitudinal position error prediction value as it is.

However, in operation S1029, if the area from which the longitudinal position can be extracted exists in the accurate map, the system for recognizing a position of a vehicle uses the longitudinal position error prediction value by adding a predetermined value (a preset value) to the previous longitudinal position error prediction value.

Then, in operations S1031 to S1033, if there is a correction value for the lateral position, the system for recognizing a position of a vehicle uses the magnitude of the lateral position correction value as the lateral position error prediction value.

Then, in operation S1035, if the lateral position correction value does not exist, the system for recognizing a position of a vehicle determines whether an area from which the lateral position can be extracted exists in the accurate map (whether the lateral matchable area exists).

In operation S1037, if the area from which the lateral position can be extracted does not exist in the accurate map, the system for recognizing a position of a vehicle uses the previous lateral position error prediction value as it is.

However, in operation S1039, if the area from which the lateral position can be extracted exists in the accurate map, the system for recognizing a position of a vehicle uses the lateral position error prediction value by adding a predetermined value (a preset value) to the previous lateral position error prediction value.

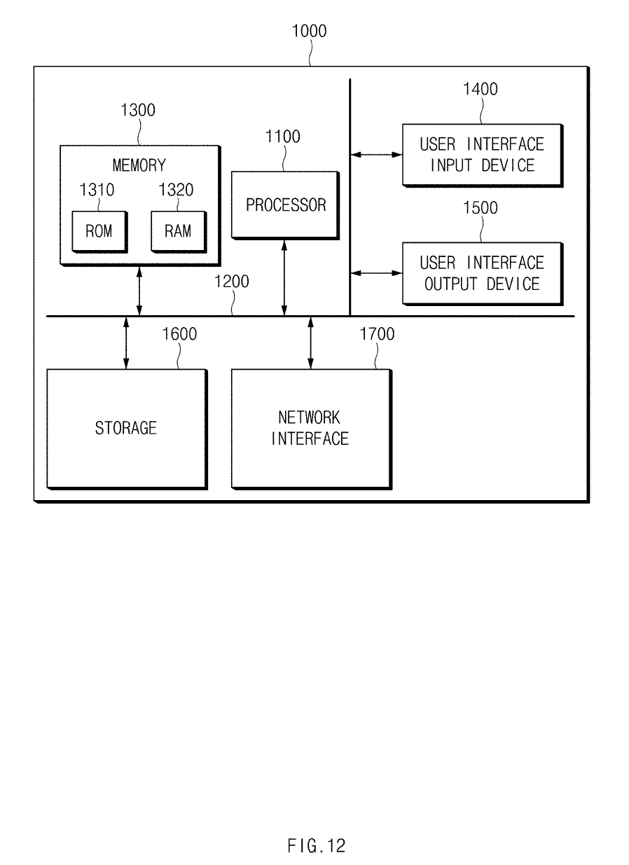

FIG. 12 is a block diagram illustrating a computer system executing a method of recognizing a position of a vehicle in some forms of the present disclosure.

Referring to FIG. 12, a computing system 1000 may include at least one processor 1100, a memory 1300, a user interface input device 1400, a user interface output device 1500, a storage 1600, and a network interface 1700, which are connected to each other through a bus 1200.

The processor 1100 may be a central processing device (CPU) or a semiconductor device which performs processing for instructions stored in the memory device 1300 and/or the storage 1600. The memory 1300 and the storage 1600 may include various types of volatile or non-volatile storage media. For example, the memory 1300 may include a read only memory (ROM) and a random access memory (RAM).

The operations of a method or algorithm described in some forms of the present disclosure may be embodied directly in hardware, in a software module executed by the processor 1100, or in a combination of the two. The software module may reside in a storage medium (that is, the memory 1300 and/or the storage 1600) such as a random access memory (RAM), a flash memory, a read only memory (ROM), an erasable programmable ROM (EPROM), an electrically erasable programmable ROM (EEPROM), registers, hard disk, a removable disk, a compact disc-ROM (CD-ROM), etc. An exemplary storage medium is coupled to the processor 1100 such that the processor 1100 may read information from, and write information to, the storage medium. Alternatively, the storage medium may be integrated into the processor 1100. The processor and the storage medium may reside in an ASIC. The ASIC may reside within a user terminal. Alternatively, the processor and the storage medium may reside in the user terminal as individual components.

The present technique, which is a method of recognizing a position of a vehicle using an image sensor, a LiDAR sensor, and a GPS, may more accurately recognize a position of a vehicle even when the GPS reception is poor.

In addition, in some forms of the present disclosure, the position of a vehicle may be stably recognized by using an error prediction value relating to the position of the vehicle.

The above-described method in some forms of the present disclosure may be recorded as a computer program. A code and a code segment constituting the program may be readily inferred by a computer programmer in the field. In addition, the program may be stored in computer-readable recording media (information storage media) and may be read and executed by a computer, thereby implementing the method of some forms of the present disclosure. The recording media may include any types of computer-readable recording media.

The description of the disclosure is merely exemplary in nature and, thus, variations that do not depart form the substance of the disclosure are intended to be within the scope of the disclosure. Such variations are not to be regarded as a departure from the spirit and scope of the disclosure.

What is claimed is:

1. A system for recognizing a position of a vehicle, the system comprising:
a lane-based position recognition device configured to extract first correction information and second correction information by comparing measured lane information with lane information on an accurate map, wherein the first correction information is correction information regarding a heading angle of the vehicle and the second correction information is correction information regarding a lateral position of the vehicle;
a Light Detection And Ranging (LiDAR)-based position recognition device configured to extract correction information regarding a position of the vehicle by detecting an area, wherein a LiDAR sensor measures surrounding vehicles and obstacles to detect the area; and
a position assembly device configured to assemble a position based on:
the first and second correction information;
LiDAR sensor-based correction information comprising the first, second, and third correction information obtained by the LiDAR sensor, wherein the third correction information is correction information regarding a longitudinal position of the vehicle; and
GPS-based correction information comprising the first, second, and third correction information obtained by a GPS.

2. A method of recognizing a position of a vehicle, the method comprising:
extracting first correction information and second correction information by comparing measured lane information with lane information on an accurate map, wherein the first correction information is correction information regarding a heading angle of the vehicle and the second correction information is correction information regarding a lateral position of the vehicle;
extracting correction information regarding a position of the vehicle by detecting an area, wherein a Light Detection And Ranging (LiDAR) sensor measures surrounding vehicles and obstacles to detect the area; and
assembling a position based on:
the first and second correction information;
LiDAR sensor-based correction information comprising the first, second, and third correction information obtained by the LiDAR sensor, wherein the third correction information is correction information regarding a longitudinal position of the vehicle; and
GPS-based correction information comprising the first, second, and third correction information obtained by a GPS.

3. The method of claim 2, further comprising:
predicting a moving route of the vehicle from a previous position to a current position before extracting the first and second correction information.

4. The method of claim 2, wherein extracting the first and second correction information comprises:
dividing a measured lane and a lane on the accurate map into a plurality of matching sections based on a longitudinal direction of the vehicle; and
matching the measured lane with the lane on the accurate map.

5. The method of claim 2, wherein assembling the position comprises:
converting a final position for any sensor of the plurality of sensors into a vehicle position-based coordinate system;
extracting the first correction information;
extracting the second correction information;
extracting the third correction information; and
converting the first, second, and third information into global coordinates.

6. The method of claim 2, wherein extracting the correction information regarding the position of the vehicle comprises:
extracting, with a LiDAR signal, an outline;
calculating a region of interest (ROI) of a matchable area from the outline;
classifying feature lines in longitudinal, lateral, and diagonal directions;
setting the matchable area based on the feature lines;
extracting the first, second, and third correction information for any outline of the plurality of outlines; and
calculating a weight for any outline of the plurality of outlines.

7. The method of claim 6, wherein classifying the feature line in the longitudinal direction comprises:
matching the feature line with the outline based on a lateral position error prediction value (E_LAT).

8. The method of claim 6, wherein classifying the feature line in the lateral direction comprises:
matching the feature line with the outline based on a longitudinal position error prediction value (E_LONG).

9. The method of claim 6, wherein classifying the feature line in the diagonal direction comprises:
when the second correction information exists, matching the feature line with the outline based on the longitudinal position error prediction value; and
when the second correction information does not exist, matching the feature line with the outline based on the lateral position error prediction value and the longitudinal position error prediction value.
